(19) United States
(12) Patent Application Publication
(10) Pub. No.: US 2023/0237497 A1
(43) Pub. Date: Jul. 27, 2023

(54) PURCHASE APPROVAL BROKERING

(71) Applicant: Capital One Services, LLC, McLean, VA (US)

(72) Inventors: Lukiih Cuan, Washington, DC (US); Salik Shah, Washington, DC (US); Andrea Montealegre, Arlinigton, VA (US)

(21) Appl. No.: 17/584,334

(22) Filed: Jan. 25, 2022

(51) Int. Cl. G06Q 20/40; G06Q 20/34; G06N 20/00; G06Q 20/38

(52) U.S. Cl. CPC G06Q 20/409; G06Q 20/351; G06N 20/00; G06Q 20/382

(57) ABSTRACT

The innovation disclosed and claimed herein, in one aspect thereof, comprises systems and methods of purchase approval brokering. The innovation can receive a request from a first user device to purchase a product. The request can include product information such as an image of the product or a unique identifier. The product may be identified from the request to purchase of the product. An approver may be determined from a set of approvers based on the identification of the product and information in the request. An approval for the purchase of the product may be requested and received from the approver. Upon receiving an approval to purchase the product, a virtual card number for purchasing may be generated. The purchase of the product may be completed by the user via the virtual card number.

### BACKGROUND

Typically, users must entrust their associates with their financial accounts for making purchases. For example, a parent may give their child their credit card information so the child can make purchases. However, the parent lacks sufficient control over the purchases charged to the credit card by the child. The child may be able to purchase whatever they please without supervision from the parent. The lack of supervision can lead to purchases that the parent does not want or to overspending for products.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of purchase approval brokering. The innovation can receive a request from a first user device to purchase a product. The request can include product information such as an image of the product or a unique identifier. The product is identified from the request to purchase of the product. An approver is determined from a set of approvers based on the identification of the product and information in the request. An approval for the purchase of the product is requested and received from the approver. Upon receiving an approval to purchase the product, a virtual card number for purchasing is generated. The virtual card number is associated with the product such that other purchases cannot be completed using the virtual card number. The purchase of the product is completed by the user via the virtual card number.

In aspects, the subject innovation provides substantial benefits in terms of purchase approval brokering. One advantage resides in a more secure control of what can be purchased with a person's accounts. Another advantage resides in remote approvals of purchases.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates a high level diagram in accordance with the subject innovation.

FIG. 2 illustrates an example component diagram of an approval broker.

FIG. 3 illustrates an example component diagram of an analysis component.

FIG. 4 illustrates an example component diagram of a transaction component.

FIG. 5 illustrates a method for purchase approval brokering.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

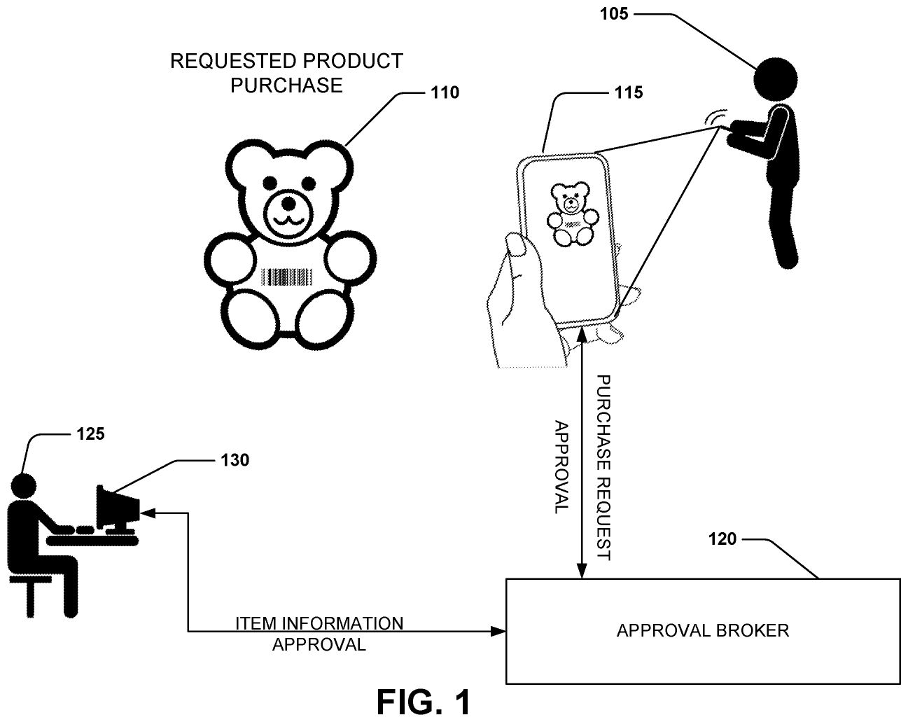

FIG. 1 illustrates a high level view of the subject innovation. A user 105 requests a purchase of a product 110 via a user device 115. The request includes product information. The product information can include a description of the product, a unique identifier of the product, image data of the product, and/or the like. In some embodiments, the request includes an image of the product. The image can be captured by the user device 115. The user device 115 can be a mobile device, a smartphone, an internet of things device, a wearable device, a personal computer, and/or the like.

The request is provided to an approval broker 120. The request can be provided to the approval broker 120 via the user device 115. The approval broker 120 can parse the request for information. The approval broker 120 can extract information such as a product identification, price, user identification, location, seller, time, and/or the like. In some embodiments, the approval broker 120 analyzes image data of the product in the request. The approval broker 120 can analyze the image data to extract a unique identifier of the product 110 such as a barcode, quick response code, stock keeping unit SKU, Universal Product Code UPC, make/model tag, label, and/or the like. The approval broker 120 can identify the product 110 via computer vision, natural language processing, optical character recognition, and/or the like.

The approval broker 120 can generate and send a notification or alert to an approver 125. In some embodiments, the approver 125 is associated with a second user device 130. The notification can be sent to the approver 125 via the second user device 130. The approver 125 can return an approval to the approval broker 120 via the second user device 130. In some embodiments, the second user device 130 can interface with the approval broker 120 via an application, website, application programming interface, and/or the like to send and receive requests, production information, approvals, and/or the like. The second user device 130 can be a mobile device, a smartphone, an internet of things device, a wearable device, personal computer, and/or the like.

In some embodiments, the approval broker 120 selects or determines an approver 125 from a set of at least two or more approvers. The set of at least two approvers can be affiliated with one another and/or the user 105. For example, the user 105 can be a child of two parent approvers. The approval broker 120 can select a parent approver from the set of two parent approvers. In some embodiments, the approval broker 120 selects the approver 125 from the set of approvers via a context learning model. In some embodiments, the selection or determination can be based on the product information of the request and the context learning model.

In some embodiments, the approval broker 120 can train the context learning model with a transaction history. The transaction history can be previous transactions of the user 105 that were approved by one of the set of approvers. The context learning model can learn approver preferences, trends, probabilities, and/or the like for determining which approver of the set of approvers is most likely to provide a decision regarding the purchase request. The context learning model can be trained on type of purchase to learn whether a particular approver is preferred for approving the specific type of purchase. For example a transaction history of a child user can train the context learning model that the child's mother typically approves or denies purchases regarding food while the child's father typically approves or denies purchases regarding toys.

The approver 125 provides an approval or denial via the second user device 130. The approval broker 120 can generate a virtual card number for purchasing the product 110 upon receiving (or receipt of) an approval for the purchase. In some embodiments, the virtual card number is used exclusively to purchase the product 110. The approval broker 120 can facilitate purchase of the product 110 by the user 105 upon receiving the approval. The approval broker 120 can provide the approval and/or the virtual card number to the user device 115. The user 105 can use the virtual card number via the user device 115 to purchase the product 110 via a point of sale system associated with a store or retailer that is selling the product 110. For example, the user 105 via the user device 115 can present the virtual card number to the point of sale system of the seller to complete purchase of the product.

The approval broker 120 can detect an attempted purchase of a second product or a different product. The approval broker 120 detects the attempted purchase by tracking the virtual card number and the requested transactions using the virtual card number. The approval broker 120 can block the attempted purchase of the second product or different product. The approval broker 120 can complete the purchase of an approved product 110 a purchase of the product via the virtual card number.

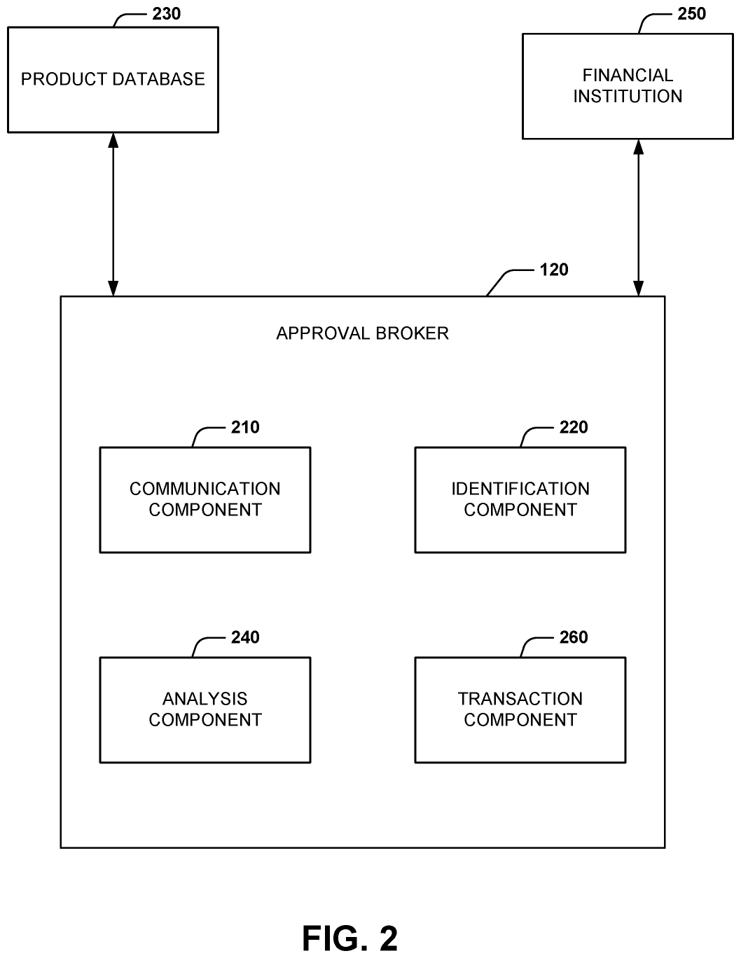

FIG. 2 illustrates an example component diagram of the approval broker 120. The approval broker 120 includes a communication component 210. The communication component 210 can communicate with a user device 115 to receive a request to purchase a product. The communication component 210 can receive the request via email, SMS, MMS, text message, application programming interface API, push notification, and/or the like. The request includes product information and purchase information. The product information can include a description of the product, a unique identifier of the product, image data of the product, and/or the like. In some embodiments, the request includes an image of the product. The image can be captured by the user device 115. The purchase information can be price of the product, the location, time, store/retailer, online sale indication, in person sale indication, and/or the like. In some embodiments, the communication component 210 can parse the request for information. The communication component 210 can extract information such as a product identification, price, user identification, location, store, time, and/or the like. In some embodiments, the request can include multiple products or a “cart” to be approved for purchasing.

In some embodiments, the approval broker 120 includes an identification component 220. The identification component 220 analyzes image data of the product in the request. The identification component 220 can analyze the image data to extract a unique identifier of the product 110 such as a barcode, quick response code, SKU, UPC, make/model tag, label, and/or the like. The identification component 220 can identify the product 110 via computer vision, natural language processing, optical character recognition, and/or other identification techniques. The identification component 220 can access a product database 230 to compare the image to known images of the product 110. In some embodiments, the product database 230 includes entries of unique markings, barcode, quick response code, SKU, UPC, make/model tag, label, and/or the like for identifying products for sale. The identification component 220 can match information from the request to a product in the product database to identify the product 110.

The communication component 210 can generate a send a notification or alert to the approver 125. In some embodiments, the approver 125 is associated with a second user device 130. The notification can be sent to the approver 125 via the second user device 130. The notification can include the request, the product identification, a user identification, and/or the like. The approver 125 can return an approval to the communication component 210 via the second user device 130. In some embodiments, the second user device 130 can interface with the communication component 210 via an application, website, application programming interface, and/or the like to send and receive requests, production information, approvals, and/or the like.

In some embodiments, the approval broker 120 includes an analysis component 240. The analysis component 240 selects an approver 125 from a set of at least two approvers. The set of at least two approvers can be affiliated with one another and/or the user 105. For example, the user 105 can be an employee of two manager approvers. The analysis component 240 can select a manager approver from the set of two approvers. In some embodiments, the analysis component 240 selects the approver 125 from the set of approvers via a context learning model. The selection or determination can be based on the product information of the request and the context learning model.

In some embodiments, the analysis component 240 can train the context learning model with a transaction history. The analysis component 240 can retrieve transaction history from a financial institution 250. The transaction history can be previous transactions of the user 105 that were approved by one of the set of approvers. The context learning model can learn approver preferences, trends, probabilities, and/or the like for determining which approver of the set of approvers is most likely to provide a decision regarding the purchase request. The context learning model can be trained on type or price of purchase to learn whether a particular approver is preferred for approving the specific type or price of purchase. For example a transaction history of the employee user can train the context learning model that one manager typically approves or denies purchases less than one hundred dollars while a different manager typically approves or denies purchases above one hundred dollars.

The approval broker 120 includes a transaction component 260. The approver 125 provides an approval or denial via the second user device 130. The transaction component 260 can generate a virtual card number for purchasing the product 110 upon receiving an approval for the purchase. In some embodiments, the virtual card number is used exclusively to purchase the product 110. The transaction component 260 can facilitate purchase of the product 110 by the user 105 upon receiving the approval.

The communication component 210 can provide the approval and/or the virtual card number to the user device 115. The user 105 can use the virtual card number via the user device 115 to purchase the product 110 via a point of sale system associated with a store or retailer that is selling the product 110. The transaction component 260 can detect an attempted purchase of a second product or a different product. The approval broker 120 detects the attempted purchase by tracking the virtual card number and the requested transactions using the virtual card number. The transaction component 260 can block the attempted purchase of the second product or different product. The transaction component 260 can complete the purchase of an approved product 110 via the virtual card number. The transaction component 260 can interface with the financial institution 250 to adjust accounts of the approver 125, the user 105, the seller, and/or the like.

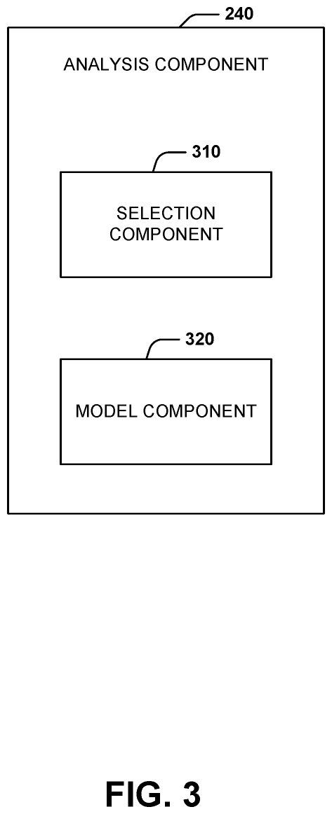

FIG. 3 illustrates an example component diagram of an analysis component 240. The analysis component 240 includes a selection component 310. The selection component 310 selects an approver 125 from a set of at least two approvers. The set of at least two approvers can be affiliated with one another and/or the user 105. For example, the user 105 can be a child of two parent approvers. The selection component 310 can select a parent approver from the set of two parent approvers. In some embodiments, the selection component 310 selects the approver 125 from the set of approvers via a context learning model. The selection or determination can be based on the product information of the request and the context learning model. The selection component 310 can base the selection via business rules, previously established rules, learned rules, and/or the like. For example, the selection component 310 can follow a previously established rule that gas station purchases are approved by one parent while entertainment purchases are approved by another parent.

In some embodiments, the analysis component 240 includes a model component 320. The model component 320 can train the context learning model with a transaction history. The model component 320 can retrieve transaction history from a financial institution 250. The transaction history can be previous transactions of the user 105 that were approved by one of the set of approvers. The context learning model can learn approver preferences, trends, probabilities, and/or the like for determining which approver of the set of approvers is most likely to provide a decision regarding the purchase request. The context learning model can be trained on type of purchase to learn whether a particular approver is preferred for approving the specific type of purchase. For example, a transaction history of the child user can train the context learning model that the child's mother typically approves or denies purchases regarding food while the child's father typically approves or denies purchases regarding toys.

In some embodiments, the model component 320 can train the model for automatic approval of a request. The model component 320 can determine automatic approval based on previous approvals/denials of requests, the identification of the product 110, the time/location, and/or the like. For example, the model component 320 can train the model on the transaction history that a parent approver always approves a purchase of an apple from a supermarket. The model can determine an automatic approval based on the transaction history. In some embodiments, the model can include a timeout feature where an automatic approval/denial can be sent to the user 105 upon a failure to respond to the request by an approver. The model component 320 can train the model for automatic approvals using supervised machine learning technique, unsupervised machine learning technique, and/or the like.

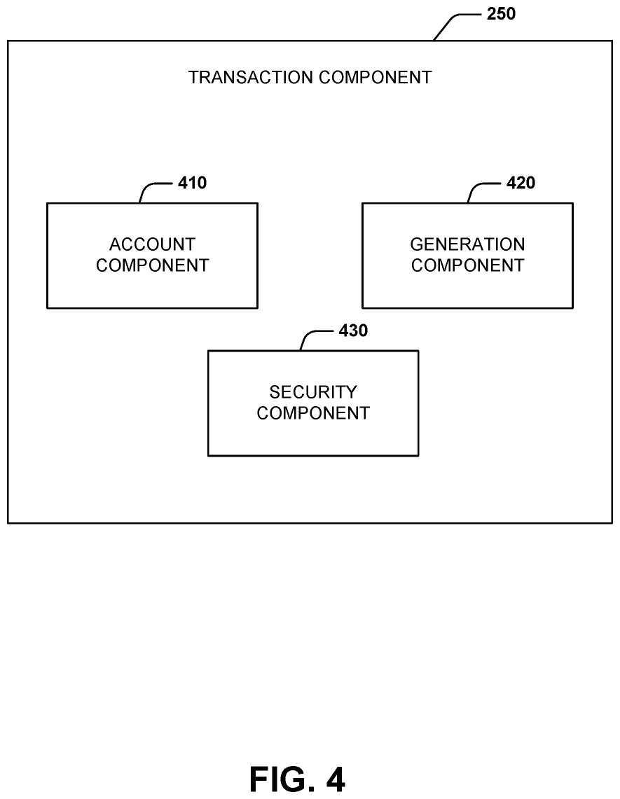

FIG. 4 illustrates an example component diagram of a transaction component 260. The transaction component 260 includes an account component 410. The account component 410 can interface with a financial institution to complete transactions using an approver account, a user account, and/or the like. The account component 410 can facilitate purchase of the product 110 by the user 105 upon receiving the approval by adjusting account for debits and/or credits at the financial institution and a retailer/store that is selling the product 110.

The transaction component 260 includes a generation component 420. Upon an approval or denial of the requested purchase, the generation component 420 can generate a virtual card number for purchasing the product 110 upon receiving an approval for the purchase. In some embodiments, the virtual card number is used a one-time unique number to purchase the product 110. The generation component 420 can generate the virtual card number using a hashgraph, a blockchain entry, a randomized card number, a one-time passcode, and/or the like. In some embodiments, the generation component 420 generates the virtual card number such that it can only be used to purchase the approved product 110.

The transaction component 260 includes a security component 430. The security component 430 can detect use of the virtual card number via the user device 115 to purchase the product 110 via a point of sale system associated with a store or retailer that is selling the product 110. The security component 430 can match an identification of the product 110 at the point of sale device to the approval of the purchase of the product 110 and/or the identification of the product 110. The security component 430 can allow or block the purchase based on a match or no match respectively.

In some embodiments, the security component 430 can detect an attempted purchase of a second product or a different product. The security component 430 detects the attempted purchase by tracking the virtual card number and the requested transactions using the virtual card number. In some embodiments, the security component 430 can interface with an inventory system of the seller to match inventory and/or prices to the request and/or approval. In other embodiments, the financial institution can partner with the seller to interface inventory systems with the security component 430. The security component 430 can block the attempted purchase of the second product or different product. The account component 410 can complete the purchase of an approved product 110 via the virtual card number by adjusting accounts of the approver and the seller via the financial institution 250.

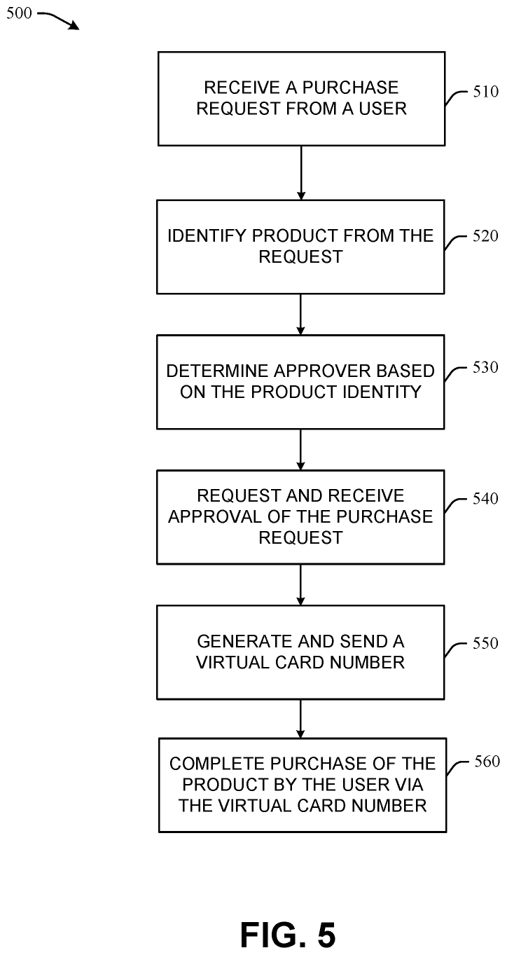

With reference to FIG. 5, example method 500 is depicted for purchase approval brokering. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 500 are described in conjunction with a specific example is for explanation purposes.

FIG. 5 illustrates a method 500 for purchase approval brokering. At 510, a purchase request is received from a user 105 to purchase a product 110. The purchase request can be submitted to an approval broker 120 via a user device 115. At 520, the product 110 is identified. The approval broker 120 can utilize different techniques to identify the product 110 such as computer vision, optical character recognition, image matching, natural language processing, unique markings/logos, and/or the like. At 530, an approver is determined or selected. The approval broker 120 can identify an approver 125 from a set of approvers (e.g. two or more approvers) based on the identification of the product, established rules, a context learning model, and/or the like. The selected approver is provided the request, product identification, product information, and/or the like.

At 540, an approval is received from, obtained, or provided by the approver 125. The approval broker 120 can receive the approval from the approver 125 via a second user device 130. At 550, upon receiving an approval from the approver 125, a virtual card number is generated and sent. The approval broker 120 generates and sends or transmits the virtual card number to the user 105 or user device 115. The virtual card number is linked to the product 110 such that other items or more than approved quantity cannot be purchased. At 560, a purchase of the product by the user 105 is completed via the virtual card number. The user 105 can present the virtual card number to a point of sale system of the seller to purchase the product 110. In some embodiments, the virtual card number can only be used to purchase approved products.

The innovation disclosed and claimed herein, in one aspect thereof, comprises systems and methods of purchase approval brokering. A method comprises: receiving a request from a first user device to purchase a product, the request including product information; receiving an approval for the purchase of the product, wherein the approval is received from a second user device; generating and transmitting a virtual card number for purchasing the product to the first user device; and transmitting the virtual card number.

A system of the innovation can include a processor coupled to a memory that includes instructions executed by the processor, the instructions comprising: identifying a product from a request to purchase of the product, the request including product information; requesting and receiving an approval for the purchase of the product from an approver; generating a virtual card number for purchasing the product; and transmitting the virtual card number.

A computer readable medium of the innovation can include instructions to control one or more processors. The processors are configured to: receive a request from a first user device to purchase a product, the request including product information; identify the product from the request to purchase of the product; determine an approver from a set of approvers based on the identification of the product; request and receive an approval for the purchase of the product from an approver; generate a virtual card number for purchasing the product based on receiving the approval; and complete a purchase of the product via the virtual card number.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

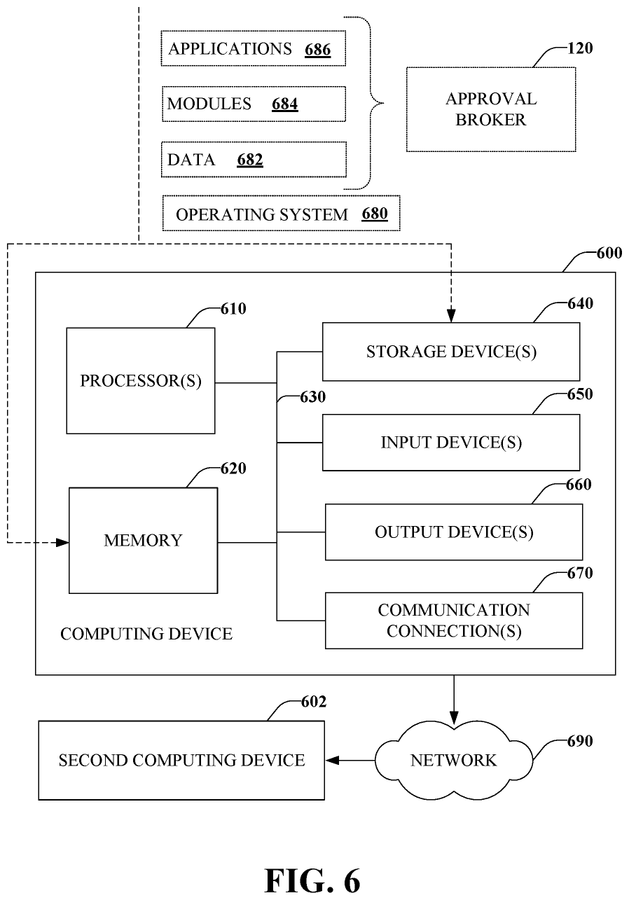

To provide a context for the disclosed subject matter, FIG. 6 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 610 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that accessible to the computing device 600 and includes volatile and nonvolatile media, and removable and non-removable media. Computer-readable media can comprise two distinct and mutually exclusive types, namely storage media and communication media.

Storage media includes volatile and nonvolatile, removable, and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 620 and storage device(s) 640 are examples of computer-readable storage media. Depending on the configuration and type of computing device, the memory 620 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 600, such as during start-up, can be stored in nonvolatile memory, while volatile memory can act as external cache memory to facilitate processing by the processor(s) 610, among other things.

The storage device(s) 640 include removable/non-removable, volatile/non-volatile storage media for storage of vast amounts of data relative to the memory 620. For example, storage device(s) 640 include, but are not limited to, one or more devices such as a magnetic or optical disk drive, floppy disk drive, flash memory, solid-state drive, or memory stick.

Memory 620 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the approval broker 120 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the approval broker 120 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth . . . ), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of the approval broker 120, and the second computing device 602 can be a user device that communications and interacts with the computing device 600.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of authorizing purchase of a product, comprising:
receiving a request from a first user device to complete a purchase of the product, the request including product information;
identifying an approver of the purchase based on the first user device and the product information;
contacting the approver at a second user device to obtain an approval to complete the purchase of the product;
receiving the approval from the second user device to complete the purchase of the product;
generating a virtual card number to be used to complete the purchase of the product based on the approval from the second user device; and
transmitting the virtual card number to the first user device for the purchase of the product.

2. The method of claim 1,
wherein the product information includes an image of the product from the first user device.

3. The method of claim 2, further comprising:
identifying the product based on a unique identifier of the product that is depicted in the image of the product.

4. The method of claim 1, wherein identifying the approver comprises:
selecting the approver from a set of two or more approvers that are associated with the first user device.

5. The method of claim 4, further comprising:
determining the approver from the set of two or more approvers via a context learning model, wherein the determination is based on the product information of the request.

6. The method of claim 5, further comprising:
training the context learning model with a transaction history of the set of two or more approvers using a machine learning technique.

7. The method of claim 6, further comprising
wherein the context learning model can determine a type of purchase from the product information of the request.

8. The method of claim 1, further comprising:
wherein the virtual card number is a one-time unique number to complete the purchase of the product.

9. The method of claim 1, further comprising:
detecting an attempted purchase of a second product via the virtual card number; and
blocking the attempted purchase of the second product.

10. A system for authorizing purchase of a product, comprising:
a processor coupled to a memory that includes instructions executed by the processor, the instructions comprising:
identify the product from a request to complete the purchase of the product received from a user device, the request including product information;
identify an approver to complete the purchase of the product based on a type of the product;
request an approval from the approver to complete the purchase of the product;
generate a virtual card number to complete the purchase of the product based on receipt of the approval; and
transmit the virtual card number to the user device for completing the purchase of the product.

11. The system of claim 10, further comprising:
wherein the request includes an image of the product from a first user device.

12. The system of claim 11, wherein the identifying of the product comprises:
analyze the image of the product according to one or more identification techniques.

13. The system of claim 10, further wherein the identifying the approver comprises:
select the approver from a set of two or more approvers associated with a user that generated the request.

14. The system of claim 13, wherein the selecting the approver comprises:
determine the approver from the set of two or more approvers via a context learning model, wherein the determination is based on the product information of the request.

15. The system of claim 14, further comprising:
train the context learning model with a transaction history of the set of two or more approvers via a machine learning technique.

16. The system of claim 15, further comprising
wherein the context learning model can determine the type of product from the product information of the request; and
determine the approver based on the type of product.

17. The system of claim 10, further comprising:
wherein the virtual card number is a one-time unique number to complete the purchase the product.

18. The system of claim 10, further comprising:
detect an attempted purchase of a different product using the virtual card number; and
block the attempted purchase of the different product.

19. A method for authorizing purchase of a product, comprising:
receiving a request to complete the purchase of the product from a first user device, the request including product information;
determining an identification of the product from the product information;
selecting an approver from a set of approvers associated with the first user device based on the identification of the product;
requesting an approval from the approver to complete the purchase of the product;
generating a virtual card number to complete the purchase of the product based on receiving the approval from the approver; and
transmitting the virtual card number to the first user device for completion of the purchase of the product.

20. The method of claim 19, wherein selecting the approver comprises:
determining the approver from the set of approvers via a context learning model, wherein the determination is based on a transaction history of the set of approvers and the identification of the product.
